(19) United States
(12) Patent Application Publication
(10) Pub. No.: US 2006/0080157 A1
(43) Pub. Date: Apr. 13, 2006

(54) Method of improving administrative functions of a business using value streams with display of status

(76) Inventor: Thomas J. Shuker, Grand Rapids, MI (US)

Correspondence Address: Miller, Canfield, Paddock and Stone P.L.C.;c/o Robert Kelley Roth, Suite 2500, 150 West Jefferson Ave., Detroit, MI, 48226, US

(21) Appl. No.: 11/248,408

(22) Filed: Oct. 12, 2005

Related U.S. Application Data
(60) Provisional application No. 60/618,198, filed on Oct. 12, 2004.

(51) Int. Cl. G06F 9/46

(52) U.S. Cl. 705/8

(57) ABSTRACT

A method for improving an administrative function of a business is disclosed comprising the steps of selecting an administrative value stream, preparing a future state value stream map based on lean concepts to create a future state administrative value stream comprising a series of steps, and implementing the future state administrative value stream. Implementing the future state administrative value stream comprises transmitting information about each of the series of steps to a visual display, and the information comprises an amount of time needed to complete a step, an amount of time between steps, a percentage complete and accurate at each step, a percentage complete and accurate for the entire administrative value stream, and a location of workflow at each step.

### RELATED APPLICATION

This application claims priority benefit of U.S. provisional patent application No. 60/618,198 filed on Oct. 12, 2004.

### FIELD OF THE INVENTION

This invention relates to improvements in methods for tracking and controlling administrative functions in a business, and more particularly to using an enterprise value stream method for mapping and improving such administrative functions and displaying the status of the value stream.

### BACKGROUND OF THE INVENTION

Each business has a series of steps or functions it uses to make a product or provide a service. Traditionally these business steps range from initial customer order to final customer delivery and have been organized based on function (engineering, sales, shipping and receiving, accounting, information technology, etc.). A value stream can be thought of as all of the steps required to enable a business to provide its customer with the desired goods or services. A value stream map is a tool to display the flow of material and information as they move through the value stream. Value stream maps can reflect the current state of business steps and can also reflect a future state of business steps. Value stream mapping have been used by manufacturing companies to help describe their manufacturing processes. Typically it has been thought that administrative processes were relatively immune to improvements through lean concepts and value stream mapping. This was because significant elements administrative processes were thought not to be visual (i.e., not easily mapped and monitored), and because of the lack of standardization in administrative processes. The only administrative processes addressed using lean concepts has been scheduling of materials in a manufacturing process, which is closely related to manufacturing processes.

U.S. Patent Publication 2004/0039625 to Malnack et al discloses a value stream process management approach and website, but does not disclose the use of current state value stream mapping, or any techniques for improving a current state map once it is created. It would be desirable to develop and implement improved administrative functions of a business that reduce costs and time associated with making a product or providing a service, especially where steps of the process occur at geographically remote locations.

### SUMMARY OF THE INVENTION

In accordance with a first aspect, a method for improving an administrative function of a business comprises the steps of selecting an administrative value stream, preparing a future state value stream map based on lean concepts to create a future state administrative value stream comprising a series of steps, and implementing the future state administrative value stream. Implementing the future state administrative value stream comprises transmitting information about each of the series of steps to a visual display, and the information comprises an amount of time needed to complete a step, an amount of time between steps, a percentage complete and accurate at each step, a percentage complete and accurate for the entire administrative value stream, and a location of workflow at each step.

From the foregoing disclosure and the following more detailed description of various preferred embodiments it will be apparent to those skilled in the art that the present invention provides a significant advance in the technology for defining, controlling and improving administrative functions in a business. Particularly significant in this regard is the potential the invention affords for providing an improved method of reducing costs and time associated with administrative functions in a business. Additional features and advantages of various preferred embodiments will be better understood in view of the detailed description provided below.

### BRIEF DESCRIPTION OF THE DRAWINGS

FIG. 1 is a flow chart showing representative administrative value streams in a business, any of which can include information technology processes.

FIG. 2 is a flow chart that outlines the process for improving information technology processes of a business using the value stream mapping process in accordance with a preferred embodiment.

FIG. 3 is a table showing the lean concepts or techniques that are used to create a future state value stream map.

FIG. 4 is a schematic view of an office setting where an accounts payable value stream is shown in accordance with a preferred embodiment, and uses display technology and wired or wireless communication to communicate the progress of jobs to all interested.

FIG. 5 is a representative example of the kind of information that can be presented on a screen or other display.

FIG. 6 is a schematic view of a supervisor's desk showing a display that has the same value stream map as FIGS. 4-5, with additional screens containing specific process data that can be used to track and manage the accounts payable value stream.

FIG. 7 shows several example communication screens that can be used to help managers evaluate performance of the administrative value steam.

FIG. 8 shows a representative administrative value stream for accounts payable where different steps are handled at different locations.

FIG. 9 shows a representative display corresponding to the accounts payable administrative value stream of FIG. 8.

FIGS. 10A-10B show an example of a current state value stream map for a pricing process entitled Product Cost Development Material Budget.

FIGS. 11A-11B show an example of a future state value stream map created from the current state value stream map of FIGS. 10A-10B using lean concepts.

FIG. 12 is an example of a current state value stream map for a patient clinic visiting process.

FIG. 13 is an example of a future state value stream map created from the current state value stream map of FIG. 12 using lean concepts.

FIG. 14 is a before and after table comparing the current administrative value stream of FIG. 12 with the future administrative value stream of FIG. 13.

It should be understood that the appended drawings are not necessarily to scale, presenting a somewhat simplified representation of various preferred features illustrative of the basic principles of the invention. The specific features of the method disclosed here will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology that many uses and design variations are possible for the method disclosed here. The following detailed discussion of various alternative and preferred features and embodiments will illustrate the general principles of the invention with reference to improved administrative functions of a business. Other embodiments suitable for other applications will be apparent to those skilled in the art given the benefit of this disclosure.

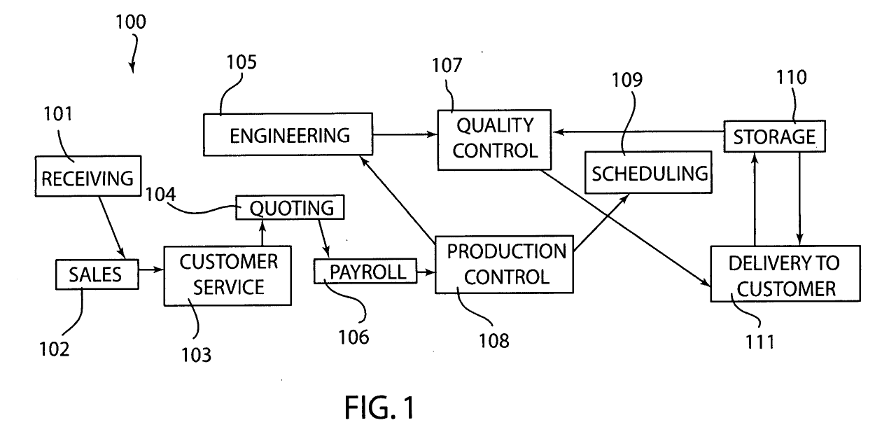

Referring now to the drawings, FIG. 1 shows a flow chart 100 of representative departments of a conventional business, organized by function, including receiving 101, sales 102, customer service 103, quoting 104, engineering 105, payroll 106, quality control 107, production control 108, scheduling 109, storage/warehouse/inventory 110, and delivery to customer 111. Information technology processes can apply to any and all of these departments, either alone or in combination, and typically comprise software modules and hardware components. As noted above, value streams are defined as all of the steps required to complete a business process, starting with customer order and ending with customer delivery of a good or service. Administrative value streams would include non-manufacturing related value streams and service value streams, such as health care value streams. Some anticipatory and monitoring elements of an administrative value stream may occur prior to order entry and after customer delivery.

Examples of concept-to-launch value streams comprise, for example, a drafting release process, a product development process, a pricing process (for goods, services, or both), a procurement of raw materials or services process, an engineering proposal process, a process for customer ordering and/or preparation of quotes for the customer, and a quality control plan release process. These value streams support a product or service that is ordered by the end customer. Examples of order-to-cash value streams comprise, for example, an order lead time process, a customer return process, a contested invoice process, a month end closing process, a new hire application process, a drafting revision process for updating documents, including CAD drawings, a product enhancement process, a clinic visit process, a clinic discharge process, and a coordination of fringe benefits process.

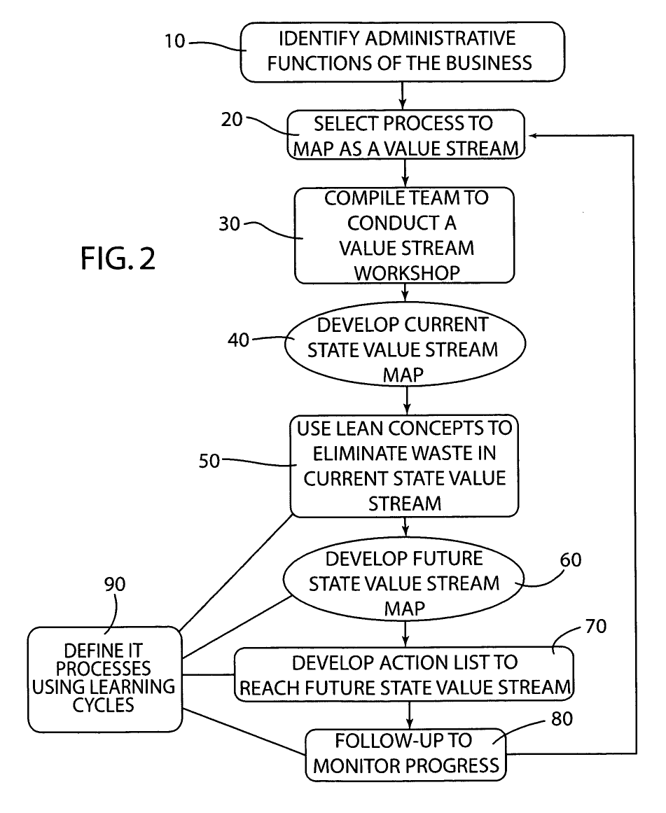

FIG. 2 is a flow chart which provides a broad overview of the value stream process 10, particularly tailored for improving IT processes. The series of steps in the process is described as follows.

10 Preparation phase. Identify the administrative business functions or group of functions of a company. Generally, business functions can be treated as one of several groups of value streams: concept-to-launch value streams and order-to-cash value streams are administrative value streams, and raw material-to-finished goods is a manufacturing value stream, and information technology processes can be considered any of these administrative value streams. Administrative value streams typically have one or more inputs from other value streams, and one or more outputs to other value streams. Inputs are the product or service of the initial or previous step in the process and can include, for example, a request for a quotation, a request for a purchase order, or an account payable. Outputs are the deliverable(s) to the next step or the ultimate end customer of the value stream and can include, for example, preparation of a quote, preparation of a purchase order, or payment on an account payable. Generally, administrative value streams receive inputs from upstream administrative value streams or suppliers and send outputs to downstream administrative value streams or customers. The terms suppliers and customers are used here only to refer to their location in the process flow relative to a selected administrative value stream. Thus, a given administrative value stream may be a customer in one instance and a supplier in another, depending on the selected administrative value stream.

At Step 20 an administrative function or process is selected for mapping as a value stream. This step involves prioritization of actions to be taken to improve administrative business functions.

Step 30. Compile a group of workers which forms a team to conduct a value stream workshop. Preferably the members of the workshop include workers experienced with the details of the selected administrative value stream. Further, the members of the workshop should include workers experienced with the details of administrative value streams which occur immediately before the targeted administrative value stream (“upstream,” or “suppliers”), and should include workers experienced with the details of administrative value streams which occur immediately after the targeted administrative value stream (“downstream,” or “customers”). As IT processes are often part of the value streams which are targeted for improvement, representatives of the IT department of the business are preferably members of the value stream workshop.

40 Draw a Current State Value Stream Map of the selected Administrative Value Stream. In accordance with a highly advantageous feature, each Current State Value Stream Map has at least the following five elements:

1. A list of all of the steps required to complete the administrative value stream.

2. A lead time for each step. The lead time is the amount of time it takes to complete each step, and is also the amount of time between steps. A total lead time is the sum of all of the lead times.

3. A process time for each step. Process time is the amount of time a worker spends actually working on a process step. This can be as much as the lead time, but not more than the lead time. A total process time is the sum of all of the process times.

4. A percentage correct and/or accurate of a given administrative value stream. A step has an input (which can include material worked on at a given step), and not necessarily all inputs are accurate. This metric determines the percent correct and accurate of the input data at that step. The Current State Value Stream Map records the rate of accuracy both at given steps and as a total percent correct. The total percent correct is the multiplier of the percent corrects at any given step in the map.

5. An information flow between steps. Information flow can comprise inputs required, including multiple inputs and inputs required from more than one other value stream) and outputs, including multiple outputs and outputs to more than one other value stream. The information flow is preferably represented on the Current State Value Stream Map as lines or arrows connecting steps.

In addition, each Current State Value Stream Map may further comprise one or more of the following:

1. A value added time for each step. This is the productive time spent actually adding value to the work done at a step. It is usually significantly less than the lead time working on a step. Optimally value added time would be equal to the process time.

2. A number of workers required for each step.

3. A number of times rework is done or revisions are required.

4. An identification of the kind of information technology used. This can be helpful in identify incompatible or semi-compatible software and hardware systems.

5. A batch size. Examples of batch size include for example, one whole days worth of purchase orders to be processed, or one whole week of accounts payable. Generally, when using lean concepts, it is desirable to reduce batch size.

6. A range of lead times for each step of an administrative value stream, an average for the lead time of all of the steps, and a standard deviation for all of the lead times for the given administrative value stream.

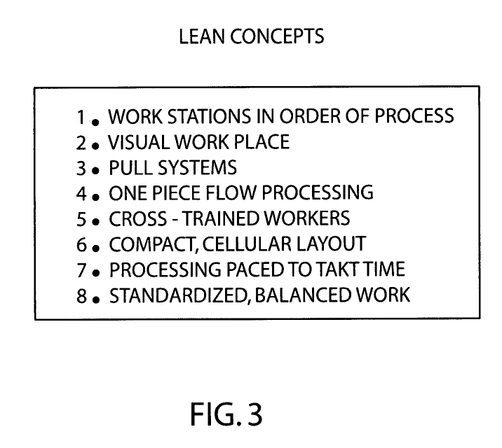

50 Use lean concepts to identify waste and inefficiency in the current state. In accordance with a highly advantageous feature, the current state value stream map is analyzed using at least one (and most preferably all) of several lean concepts. These lean concepts comprise, for example, the list on FIG. 3, discussed in detail as follows.

1. Organizing work stations (a place where a worker works) in the order of each step of an administrative value stream (i.e., by work flow), in contrast to traditional organization of work stations by function.

2. Presenting a visual status of the administrative value stream to workers working on that value stream. This may take the form of posters mounted on a wall indicating work flow, or an electronic presentation. Provisions may be made for updating the visual status as steps of the administrative value stream are completed, and for providing data for monitoring the administrative value stream.

3. Balancing workflow between steps of the administrative value stream. Each step has a lead time. Generally, it is preferably to have the lead times be as short as possible. It is advantageous that the lead times between steps be similar, as workers work at each step can be made more even and more equitable. Thus, a standard deviation of lead times for a given administrative value stream should be as small as possible.

4. Reducing Batch size. Large batch sizes can overwhelm a process, making it difficult to balance steps and reduce overall process time.

5. Cross-training workers. Advantageously cooperating with the lean concept of balancing workflow is cross-training of workers. The amount of work to be done at each step is (if balanced) roughly the same, and so, it is easier for cross-trained workers to fill in for one another. Also, cross-training is advantageous for boosting morale by providing a better understanding of the work or others in the organization and by providing new intellectual stimulation at work.

6. Tying information together on the administrative value stream, instead of merely organizing workers by function. This advantageously reduces the amount of time spent traveling between workers, reducing overall process time.

7. Setting a pace of the administrative value stream based on available time divided by customer demand. Takt time is defined as available time for a process divided by customer demand so that product flows at a rate determined by the customer. Takt time is a useful measurable for establishing the rate or pace the administrative value stream needs to produce to meet customer demand.

8. Standardizing work done by different workers working on the same administrative value stream. This involves agreeing on a set of procedures for performance of work as it is done by different workers working on the same administrative value stream.

Returning to FIG. 2, Step 60 comprises drawing a Future State Map. This Future State Map reduces lead time for each step, the overall lead time for all of the steps, the standard deviation of the lead time for all of the steps of a given administrative value stream, the process time for each step, and rework inside the process, using the lean concepts discussed above.

70 Develop an action list describing what will happen and when it will happen to implement the future state administrative value stream. This list can include new requirements for the IT department to develop new software to help create the future state. The future state administrative value stream may be checked for potentially patentable subject matter.

80 Monitoring the implementation of the future state administrative value stream. If necessary, the process may be repeated.

Since many administrative processes have elements which are performed on computer, the software needed to support the new process as defined by the future state value stream map has to be developed. Each of the last several steps of FIG. 2 can have IT processes associated with them that can be improved: 50 using lean concepts to eliminate waste in the current state value stream; 60 developing a future state value stream map with improved IT processes; 70 developing an action list to reach the future state value stream; and 80 following-up to monitor progress, may be applied to IT processes. The IT processes for each of these steps may be defined using learning cycles at step 90.

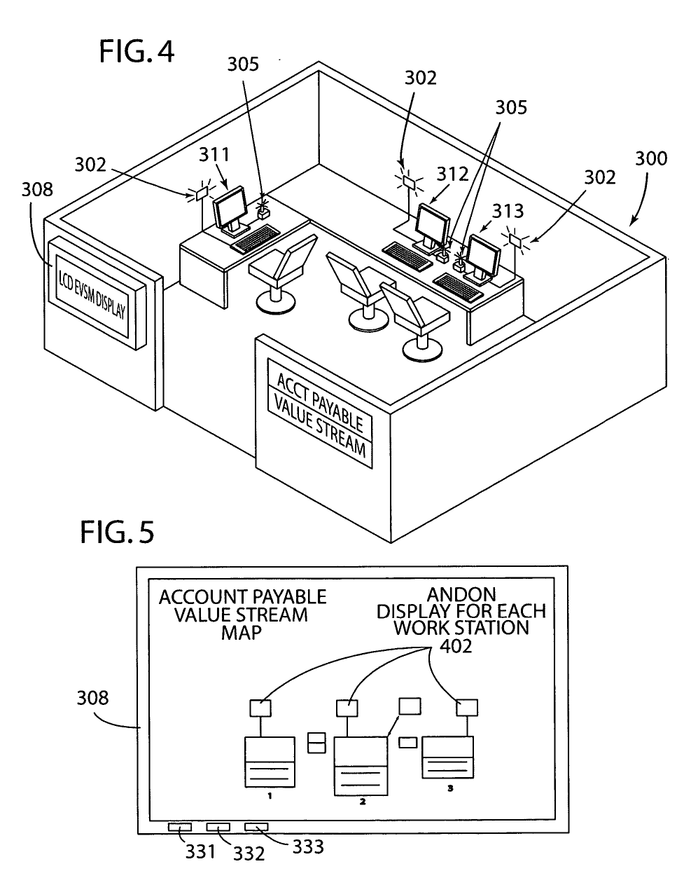

FIG. 4 shows an example of an administrative value stream; here, an accounts payable process in an office work cell 300. Inside the cell are computers where an operator performs some of the steps of the value stream. In the embodiment shown in FIG. 4, three separate computers 311, 312, 313 are shown, with each computer corresponding to a step in the accounts payable administrative value stream. In accordance with a highly advantageous feature, the administrative value stream incorporates display technology including Andon lights 302 and visual displays 308 which can show several types of information. Andon lights (Andon is the Japanese word for signal) are used by a worker to halt the value stream when some aspect of the process needs attention.

Andon lights can 302 reflect potential quality problems identified by an operator or the need for materials replenishment, failure to reach a certain number of units completed and or an unacceptably high number of defects. Typically Andon lights comprise a system of flashing lights used to indicate production status in one or more work centers. The number of lights and their possible colors can vary, even by work cell; however, the traditional colors and their meanings are: green—no problems, yellow—situation requires attention, red—process stopped; attention urgently needed. Preferably Andon lights are positioned at each station in the workflow process.

Information about each step in the administrative value stream process is preferably transmitted to a display 308, such as an LCD display positioned generally adjacent the work cell 300. The display 308 may provide several kinds of information, such as, for example the entire value stream in real time, time to complete a step in the process, wait time between process steps, percent complete and accurate for each step and for the entire administrative value stream, and location of work in the administrative value stream. FIG. 5 shows an accounts payable administrative value stream map display developed as discussed above in FIG. 4 and further includes Andon light indicators 402 for each work station or each step in the accounts payable value stream. This display provides real-time information about each step in the administrative value stream by continuously updating information displayed as work is completed at each step. Optionally the presentation may be provided with a series of buttons 331, 332, 333 to switch between the administrative value stream map, a workflow balance display and a held needed display, as discussed in greater detail below.

The interface between computers used at various steps in the value stream and the displays may be electrical, and/or may optionally be connected via wireless interfaces 305, typically a RF signal which is converted back to an electronic signal at a geographically remote location. Information or status about each step may also be transmitted by an embedded signal in software present in the computer used at each step. Alternatively, an embedded signal may be formed as a tag added to a paper folder or document. The embedded signal can transmit information about the status of the workflow. For example, once a particular step has been completed, the software can generate a signal to send to the displays indicating that step has been completed, it's time to completion, other status metrics, etc., and a confirmation signal acknowledging receipt may be sent and received. When the status of the step of the administrative value stream is transmitted to the display 308, it is displayed for all who are interested. The status can include information regarding estimated time to completion of a process step, or percentage completion of the total process, for example. The embedded technology signal can advantageously act as an electronic document tag, providing information about a step of a value stream process which can be remotely communicated. Optionally this communication may be handled by a users own server network or be available on the internet at a secured network third party provider. Wireless interfaces and embedded signals may be advantageous where various steps of the administrative value stream are geographically remote from one another.

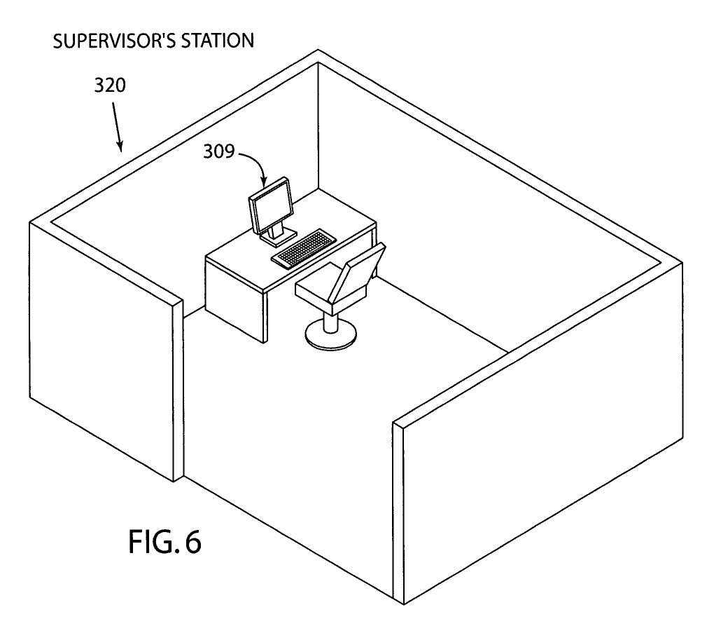

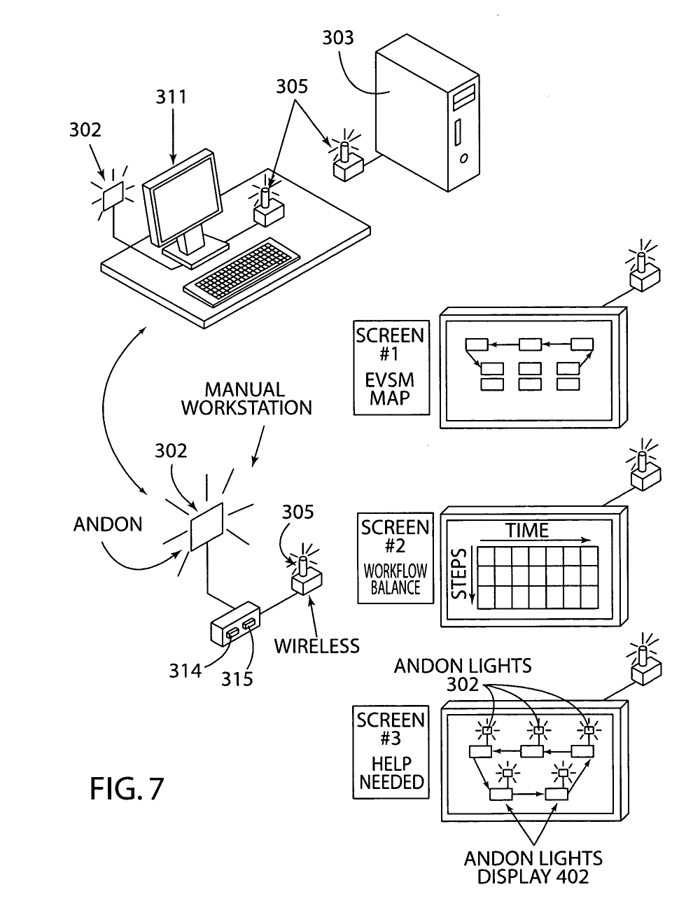

FIG. 6 is a supervisor's station 320 that shows a display screen 309 as a monitor on a computer. Monitor 309 has the same value stream map displayed as at 308. The supervisor can see on the value stream map any steps that may be having problems meeting demand or that need assistance. Further, the supervisor can be automatically alerted if a predetermined level of backlog occurs and may also be signaled by an employee at a workstation in need of assistance. FIG. 7 shows the kinds of information which may be presented at displays 308, 309. Screen 1 is the enterprise administrative value stream map (“EVSM”) as in FIG. 5. Screen 2 is a workflow balance screen which effectively provides a visual technique to monitor administrative process flow and determine whether the work is falling behind schedule. Generally the steps of the administrative value stream are listed on the y-axis, and time is listed on the x-axis. This produces a graphical plot which is useful for convey large amounts of information quickly. Preferably each step is relatively equal in time, and this workflow balance (also referred to as a leveling box) display can show real time data on how quickly each step is being performed, advantageously rapidly identifying potential bottlenecks. Screen 3 is a help needed display, showing indicators corresponding to the series of Andon lights at each step in the process. For example, a certain number of receivables may be received and allow to accumulate, but if that number is exceeded (indicating a high volume of work) an Andon light may be triggered along with the corresponding indicator, letting management know that there is a problem. Another example would be falling below an acceptable rate of percent complete an accurate.

The workstations may either have a computer or provide a manual workstation which may preferably be wirelessly connected to a server or computer 303. Manual stations may be provided with a switch 314 to indicate completion of a step in a process, and a help needed button 315 to activate the Andon light when there is a problem.

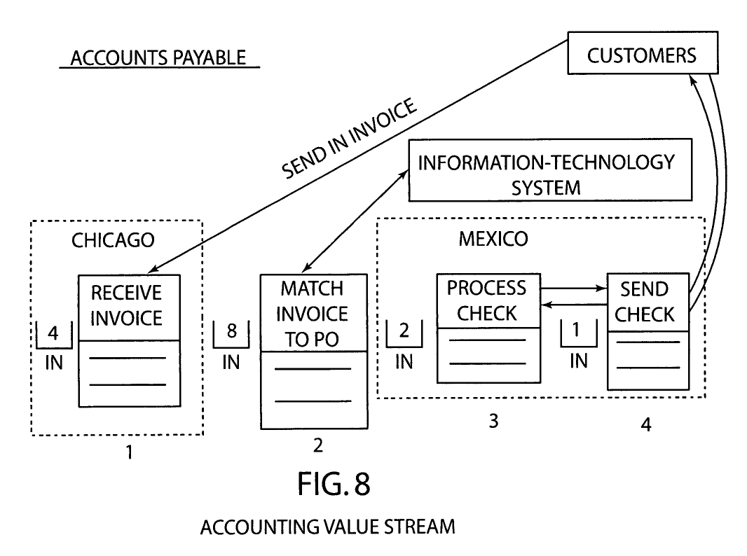

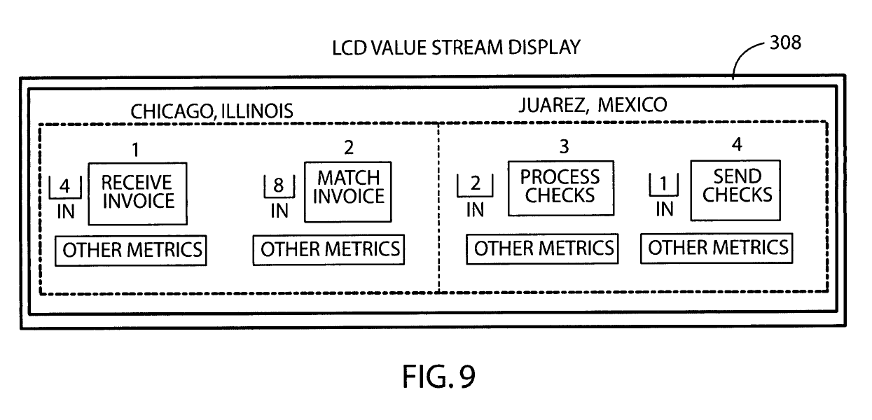

FIGS. 8-9 disclose an accounts payable administrative value stream with steps occurring at geographically remote locations. In this four step process, customers send their invoices to a Chicago address, where they are received, docketed and the invoice is matched to a purchase order. A computer, optionally remote from Chicago, may be used as part of an information technology system which takes the information input at Chicago and relays it to a remote geographic location, for example, Juarez Mexico. At Juarez, a check may be processed and sent to the customer. Advantageously each step may be recorded and transmitted wirelessly (or electronically) to remote sites, freeing allocation of resources based largely on geographic constraints. FIG. 9 shows a representative administrative value stream on an LCD display 308, with the number of projects or cases sitting at each respective step in an electronic in-basket as a first metric which can be displayed. Other metrics may include, for example, the amount of time sitting at each step, or a percentage of a total time or total estimated time, for example. The information presented in this display is powerful management tool by showing a real-time indicator of where the work in the value stream is located. Advantageously, this process may be applied to other administrative value streams with separated geographic locations for the steps of the process, such as, for example viewing and reading X-rays by a radiologist. X-rays may be taken in a US hospital, digitized and sent to India and displayed there. In India, a radiologist can read the X-ray and prepare a diagnosis which can then be sent back to the patient in the US.

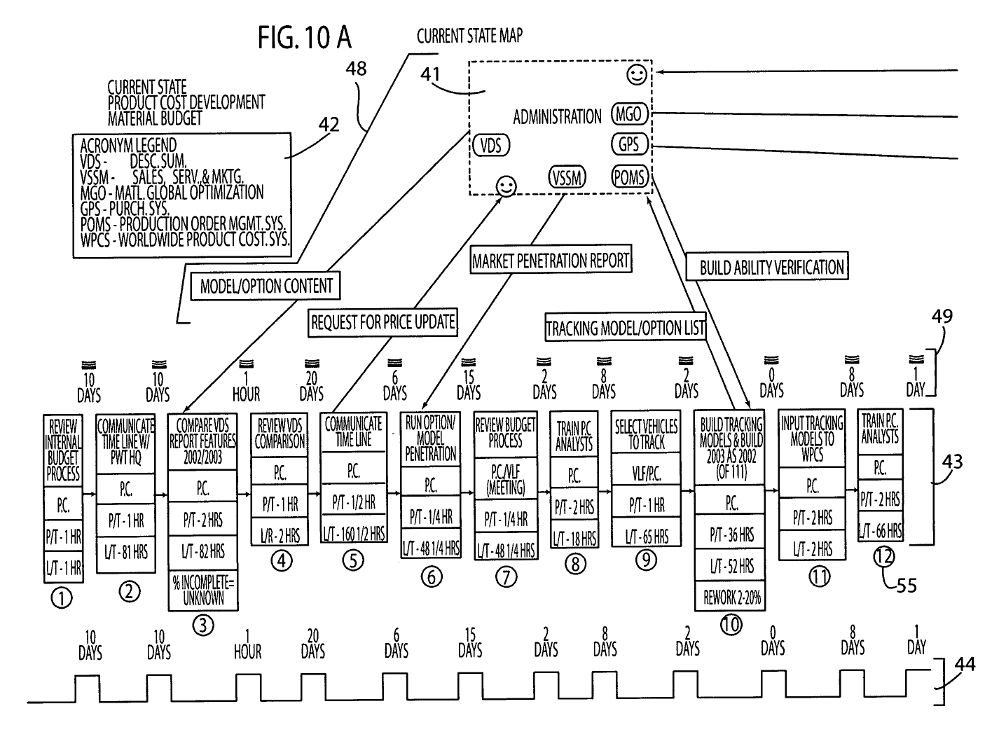

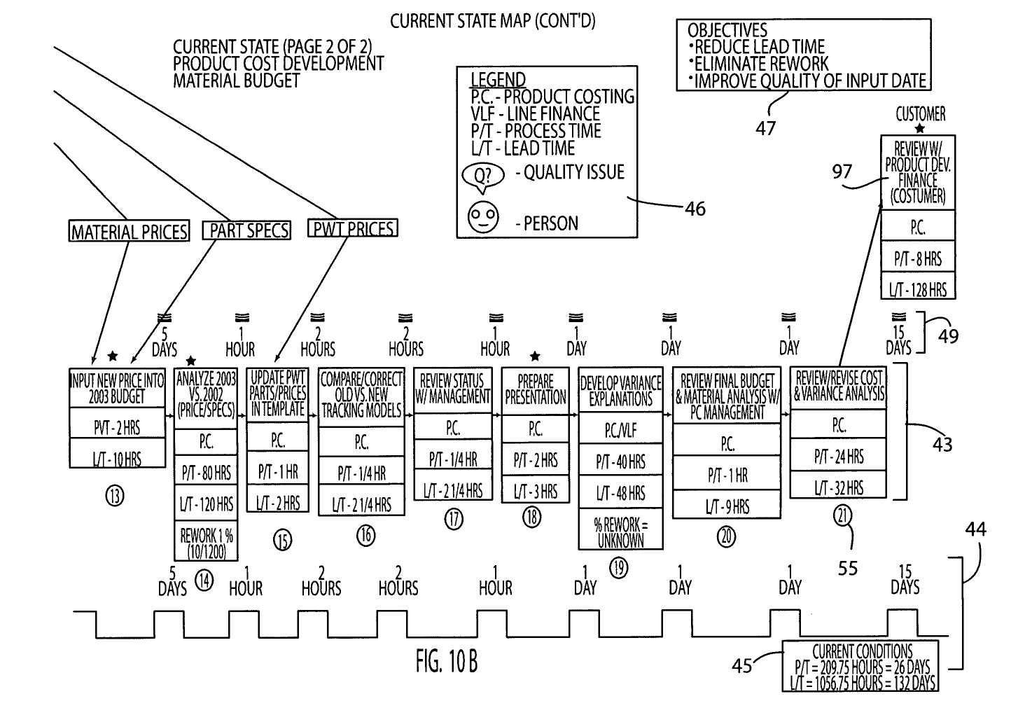

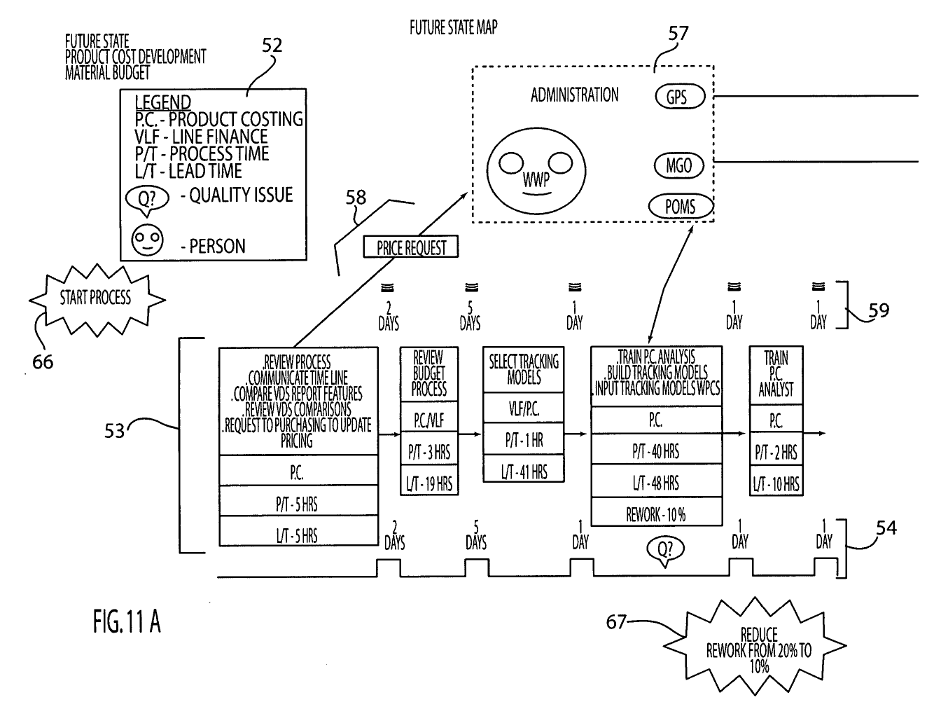

FIGS. 10A-14 disclose various examples of administrative processes improved using value stream maps. FIGS. 10A-10B provide an example of a current state administrative value stream map. In this case, the administrative function is a concept-to-launch value stream, a pricing process called “Product Cost Development.” A team was created and a workshop convened. Principle goals of the value stream mapping workshop was to reduce cost and lead-time. Generally, other goals of a value stream mapping workshop comprise increasing quality, reducing information flow and increasing percent correct and accurate at each step. Information technology processes here can include the use of cost estimate software. The current state map in FIGS. 1A-10B has been developed with the assistance of those experienced with the given administrative value stream, including those who perform the processes each day. The current state value stream map includes both material and information flow. The current state map allows team members to see and agree on how the process currently operates in order to bring a product or service to completion.

In this exemplar map, there are twenty-one steps 55, shown in a row of process and data boxes 43. Process and data boxes identify the step, show lead times and process times, and where applicable (as in steps 3, 10, 14 and 19) a percentage correct or accurate. The lead times are shown twice, once in row 49 above the row 43 and once below row 43 in row 44 in a slightly different format. To help simplify the map and increase the amount of information that can be placed on the map, acronyms are used. An acronym legend 42 is provided on FIG. 10A and another legend 46 is provided on FIG. 10B. For example, a stylized Q is provided to indicate places where the data may be somewhat subjective or difficult to quantify. FIG. 10A shows an administration box 41 with various acronyms referring to elements of administration. The smiley face is representative of a person. Information flows 48 are shown and labeled, and where the information flows to a person, a smiley face is used. FIG. 10B completes the current state value stream map, and has a list of objectives 47, an end customer or customers 97 which receives outputs, and a summary box 45 which lists total lead time and total process time.

The team used lean concepts to identify waste within the administrative value stream. The following types of waste were reviewed:
Overprocessing—performing more work than is needed
Overproduction—performing the work faster than is needed
Correction—reviewing for or making errors
Waiting—waiting for responses or information to complete the task
Motion—excess movement to complete the task
Inventory—excess work that needs to be completed
Material Movement—moving material to the next process.

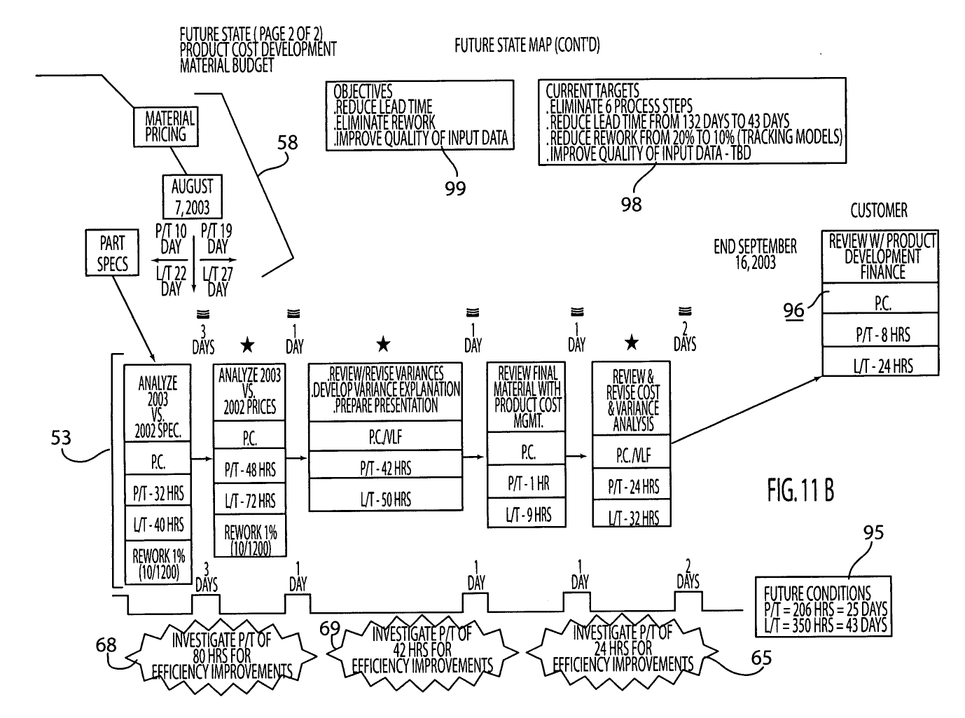

The team then worked to develop a future state administrative value stream map. This is a map of how the team thinks the process will operate, with as little of the waste identified as possible. FIGS. 11A-11B shows an example of a future state administrative value stream map for the pricing process called “Product Cost Development” based upon the corresponding current state administrative value stream map shown in FIGS. 1A-10B. Using lean concepts, the number of steps has been reduced from 21 to 11, the total lead time has been reduced from 132 days to 43 days, and the total process time has been reduced from 26 days to 25 days. (See Summary box 98 in FIG. 10B).

As before, a legend 52 is provided, and an administrative box 57. Starbursts 65-69 on the future state administrative value stream map represent kaizen or continuous improvement actions that should occur to reach the future state process. At each starburst, the team is to prioritize the continuous improvement actions and assign champions and completion dates to each action to ensure that they are completed. This serves as part of a visual tool for an action list for implementation of the future state. Future state work flows 58 are shown, along with future state data and process boxes 53 and future state lean times 54 and 59. A list of objectives 99 is provided, along with a goal list 98 of current measurable targets. The receiving agent of the outputs is the end customer(s) 96. A summary box 95 shows total lead time and total process time for the future state administrative value stream. Preferably each step has information transmitted to a display so that management can track the progress of a process step by step, detect bottlenecks, and use the data generated to refine and improve the administrative value stream.

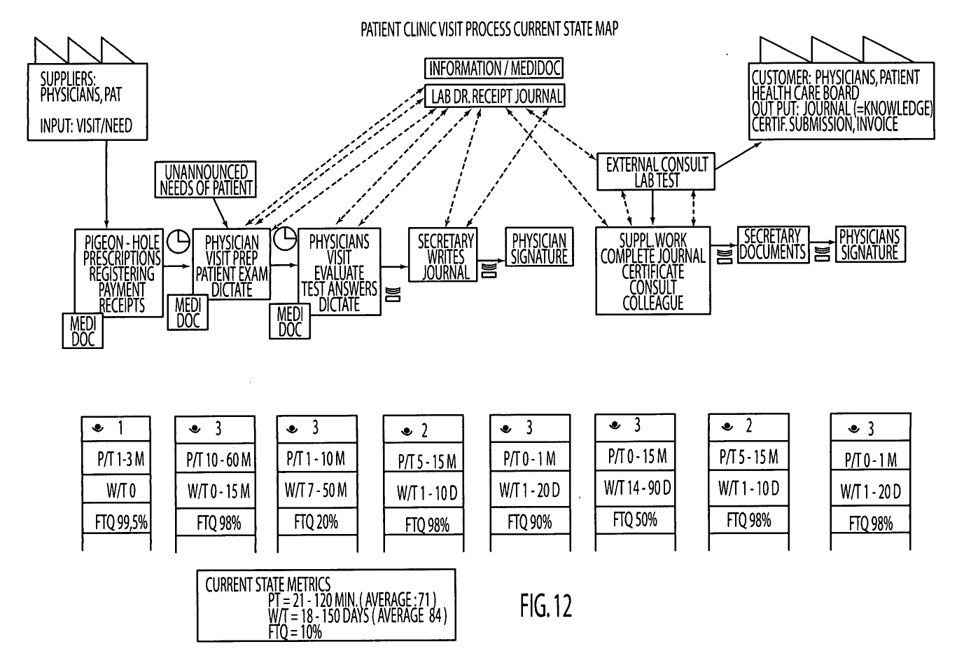

FIG. 12 provides an example of another current state administrative value stream map, an order-to-cash value stream entitled “Patient Clinic Visit Process”. Information work flow 228, data and process boxes 229, and a summary box 230 are provided. The summary box 230 provides total lead time, total process time and total percentage correct. Information processes may include input of patient information, tracking of patient procedures, and tracking of payments and costs.

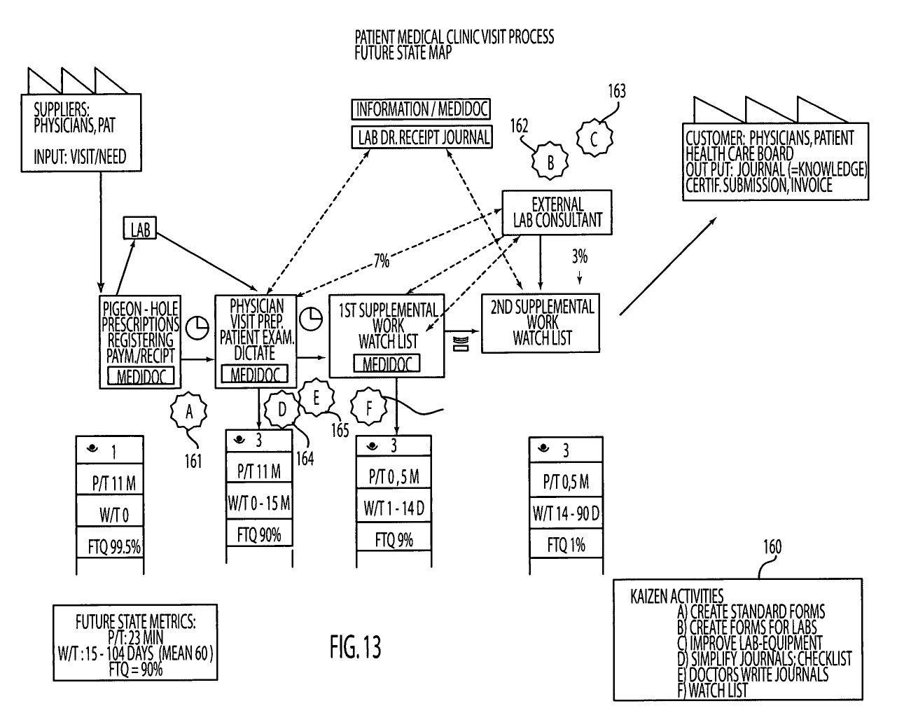

FIG. 13 provides an example of a future state administrative value stream map, based on application of lean concepts to the Patient Clinic Visit Process of FIG. 12. Kaizen activities 161-166, similar to the starbursts of FIG. 10B, are labeled in box 160. A work flow 338 is shown, along with data and process boxed 339, and a summary box 330 entitled “Future State Metrics”. Preferably each step in this process has information transmitted to a display so that management can track the progress of a process step by step, detect bottlenecks, and improve the administrative value stream.

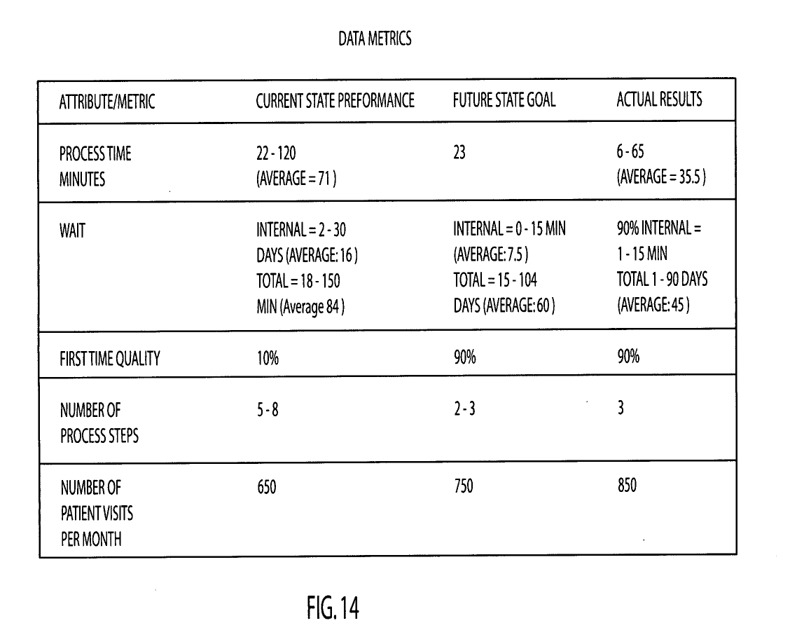

Box 330 is not a report of the actual measurements upon implementation of the future state administrative value stream. Rather, these metrics represent measurable goals. FIG. 14 is a comparison of the data metrics generated from the current state administrative value stream map of FIG. 12 and the future state administrative value stream map of FIG. 13, with the actual results after implementation. Thus, the actual results are monitored for comparison with what was expected to be achieved in the future state map.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for improving an administrative function of a business comprising, in combination, the steps of:
preparing a future state value stream map for an administrative value stream based on lean concepts to create a future state administrative value stream comprising a series of steps; and
implementing the future state administrative value stream;
wherein implementing the future state administrative value stream comprises
transmitting information about each of the series of steps to a visual display, and the information comprises at least one of an amount of time needed to complete a step, an amount of time between steps, a percentage complete and accurate at each step, a percentage complete and accurate for the entire administrative value stream, and a location of workflow at each step.

2. The method of claim 1 wherein the display shows one of the administrative value stream map; a workflow balance map and a help needed map.

3. The method of claim 2 wherein the display shows the administrative value stream map and an and on display corresponding to an and on light positioned at each step in the administrative value stream.

4. The method of claim 2 wherein the workflow balance map displays the series of steps of the administrative value stream graphically plotted against time.

5. The method of claim 2 wherein the help needed map displays an and on display corresponding to an and on light positioned at each step in the administrative value stream

6. The method of claim 1 wherein at least one of the series of steps is geographically remote from at least one of another of the series of steps.

7. The method of claim 1 wherein the display is wirelessly connected to a computer at a step in the future state administrative value stream.

8. The method of claim 1 wherein an embedded signal transmits information about the step to the display.

9. The method of claim 1 further comprising placing an and on light at a workstation corresponding to at least one of the series of steps.

10. The method of claim 1 wherein the administrative value stream comprises at least one of the groups of concept-to-launch value streams and order-to-cash value streams.

11. The method of claim 10 wherein the group of concept-to-launch value streams comprises at least one of:
a drafting release process;
a pricing process;
a procurement process;
an engineering proposal process;
a process for customer ordering and preparation of quotes for the customer;
a product development process; and
a control plan release process.

12. The method of claim 10 wherein the group of order-to-cash value streams comprises at least one of:
an order lead time process;
a customer return process;
a contested invoice process;
a month end closing process;
a new hire application process;
a drafting revision process;
a product enhancement process;
a clinic visit process;
a clinic discharge process; and
a coordination of benefits process.

13. The method of claim 1 wherein the current state value stream map contains at least:
a list of steps of an administrative value stream;
a lead time of each step;
a process time for each step;
a total percentage correct for the administrative value stream; and
an information flow between steps.

14. The method of claim 13 wherein the current state value stream map further comprises at least one of:
a value added time for each step;
a number of workers required for each step;
a number of times rework was done or revisions required;
an identification of the kind of information technology used;
a batch size; and
a range and average for the lead time for at least one of the steps of the administrative value stream.

15. The method of claim 1 wherein the lean concepts comprise at least one of:
organizing work stations in the order of each step of an administrative value stream;
presenting visual status of the administrative value stream to workers working on that value stream;
balancing workflow between steps of the administrative value stream;
reducing batch size;
cross-training workers;
placing workers together who work together on the administrative value stream;
setting a pace of the administrative value stream based on available time divided by customer demand; and
standardizing work done by different workers working on the same administrative value stream.
